(19) United States
(12) Patent Application Publication
(10) Pub. No.: US 2022/0365841 A1
(43) Pub. Date: Nov. 17, 2022

(54) REPAIR SUPPORT SYSTEM AND REPAIR SUPPORT METHOD

(71) Applicant: Hitachi, Ltd., Tokyo (JP)

(72) Inventors: Takuto YAMAGUCHI, Tokyo (JP); Sho MIZUNO, Tokyo (JP); Kenji SUGIYAMA, Tokyo (JP)

(73) Assignee: Hitachi, Ltd., Tokyo (JP)

(21) Appl. No.: 17/633,745

(22) PCT Filed: Mar. 19, 2020
(86) PCT No.: PCT/JP2020/012431

§ 371 Date: Feb. 8, 2022

(51) Int. Cl. G06F 11/07

(52) U.S. Cl. CPC G06F 11/0793; G06F 11/0775; G06F 11/0772

(57) ABSTRACT

A probability calculation result database includes a combination countermeasure table having an error code group including an error code of a repair target apparatus and a plurality error code indicating the relevant error code appeared in the past, as well as a countermeasure content against the error code and the plurality error code, and probabilities that the countermeasure content against both the error code and the plurality error code are taken respectively; a data processing unit which generates a combination table containing a new error code and a new plurality error code from apparatus error information obtained from the repair target apparatus, and repair prediction processing for predicting recommendable countermeasure contents against the new error code and plurality error code on the basis of the combination table and the probability calculation result database; and a result processing unit for providing the results of the repair prediction processing in order.

### TECHNICAL FIELD

The present invention relates to repair support systems and repair support methods.

### BACKGROUND ART

Heretofore, there have been various technologies for supporting countermeasures against failures that occur in apparatuses and instruments. For example, PTL 1 discloses a technology in which an extraction unit specifies formats for the respective error logs obtained from a monitoring target apparatus, and extracts each of the specified formats as a log pattern. Subsequently, a generation unit decides to which log pattern each of error logs that are included per day corresponds, and generates a log pattern list including log patterns. Successively, a calculation unit calculates the degree of similarity between an error log at the time a failure occurs and an error log on a day an incident occurs on the basis the error log at the time the failure occurs and a log pattern list on the day an incident occurs, and an output unit outputs a failure countermeasure against the incident that is predicted from the error log at the time the failure occurs on the basis of the degree of similarity.

### CITATION LIST

### Patent Literature

PTL 1: Japanese Patent Application Laid-Open No. 2019-49802

### SUMMARY OF INVENTION

### Technical Problem

In PTL 1, a countermeasure against an incident that is predicted from an error log at the time a failure occurs on the basis the degree of similarity between the error log at the time the failure occurs and a log pattern list on a day an incident occurs. However, for example, in the case of an apparatus or an instrument including complex mechanisms inside such as an ATM (Automated Teller Machine), it may be difficult to specify the true failure portion of the apparatus or instrument with the use of only the degree of similarity of an error log taken as a criterion. For example, in the case where, although an error is issued from the bill storage unit of an ATM, in reality the function of the bill-feed channel of the ATM from which bills fed is a failure state or the failure state of a bidirectional feed channel is due to the malfunction of a switching gate for the bidirectional feed channel, that is to say, in the case where an error is issued from a portion other than a true failure portion, it is difficult to predict a portion to be repaired. In such a case, deep experience and excellent skill of an engineer is essential to solve the problem, and if an inexperienced and unskilled engineer is in charge of repairing such an apparatus or an instrument, a considerable amount of maintenance cost is required.

One aspect of the present invention is to provide a repair support system and a repair support method that are capable of accurately providing information for making a judgment to specify a true failure portion.

### Solution to Problem

A repair support system according to an aspect of the present invention is configured as a repair support system that includes: a probability calculation result database including a combination countermeasure table in which an error code group including an error code of a repair target apparatus and a plurality error code which indicates that the relevant error code appeared a plurality of times in the past, as well as a countermeasure content against each of the error code and the plurality error code are associated with each other and stored, and probabilities that the countermeasure content against the error code and the countermeasure content against the plurality error code are taken respectively where the probabilities are obtained from predefined calculation formulas; a data processing unit that performs combination generation processing for generating a combination table containing a new error code and a new plurality error code from apparatus error information obtained from the repair target apparatus, and repair prediction processing for predicting recommendable countermeasure contents against the new error code and the new plurality error code on the basis of the combination table and the probability calculation result database; and a result processing unit for providing, to a user, the results of the repair prediction processing in order.

### Advantageous Effects of Invention

According to an aspect of the present invention, it is possible to accurately provide information for making a judgment to specify a true failure portion.

### BRIEF DESCRIPTION OF DRAWINGS

FIG. 1 is a drawing showing a functional configuration example of a repair support system according to the present embodiment.

FIG. 2 is a schematic diagram showing the hardware configuration of a computer.

FIG. 3 is a diagram showing an example of a flowchart for prior data accumulation/calculation processing performed by a prior processing server.

FIG. 4 is a diagram showing an example of apparatus error history information.

FIG. 5 is a diagram showing examples of condition information and background information both of which are included in apparatus background information.

FIG. 6 is a diagram showing an example of correct repair countermeasure information.

FIG. 7 is a diagram showing an example of apparatus error history information after code conversion.

FIG. 8 is a diagram showing examples of integral code tables redefined by a data processing unit.

FIG. 9 is a diagram showing examples of combination countermeasure tables.

FIG. 10 is a diagram showing an example of a probability calculation result DB.

FIG. 11 is a diagram showing an example of decided repair information.

FIG. 12 is a diagram showing an example of a flowchart for prediction processing performed by a prediction server.

FIG. 13 is a diagram showing an example of apparatus error information obtained by the data obtention unit of the prediction server.

FIG. 14 is a diagram showing an example of a combination table.

FIG. 15 is a diagram showing an example of a repair prediction result.

FIG. 16 is a diagram showing an example of recommendable repair information.

### DESCRIPTION OF EMBODIMENTS

Hereinafter, an embodiment of the present invention will be explained with reference to the accompanying drawings. The following descriptions and drawings are exemplified for explaining the present invention, and are appropriately abbreviated and simplified for clarify the explanation. The present invention can be implemented in other various embodiments. The number of each component of the present invention may be singular or plural if not otherwise specified.

There are some cases where, in order to make the present invention more easily understood, the locations, sizes, shapes, ranges, and the like of respective components depicted in the drawings are differently from what those really are. Therefore, the present invention is not necessarily limited to the locations, sizes, shapes, ranges, and the like of the respective components disclosed in the drawings.

In the following descriptions, various types of information will be explained in the representations of “Table”, “List”, and the like in some cases, the various types of information may be represented in data structures other than “Table” and “List”. In order to show that the representations of the various types of information do not depend on specified data structures, “XX Table”, “XX List”, or the like is referred to as “XX Information” in some cases, for example. In the case of explaining identification information, although representations such as “Identification Information”, “Identifier”, “Name”, “ID”, and “Number” are used, these representations can be replaced with one another.

If there are plural components having the same functions or similar functions, the plural components are explained while the plural components are given the same reference signs having subscripts different from one another in some cases. However, if it is not necessary to distinguish these plural components from one another, the plural components are explained with the subscripts omitted.

In addition, in the following descriptions, there are some cases where pieces of processing performed by executing programs will be explained, and the programs are executed by a processor (for example, a CPU (Central Processing Unit), or a GPU (Graphics Processing Unit)) while predefined types of processing are performed by the processor using storage resources (for example, memories) and/or interface devices (for example, communication ports) appropriately, so that it can be interpreted that the main actor of the pieces of processing can be interpreted as the processor. Similarly, the main actor of processing performed by executing the programs may be a controller, an apparatus, a system, a computer, or a node as long as a processor is imbedded in each of these instruments. Furthermore, the main actor of processing performed by executing the programs may be a computing unit, and it is all right if the computing unit includes a dedicated circuit for performing specific processing (for example, an FPGA (Field-Programmable Gate Array) or an ASIC (Application Specific Integrated Circuit)).

The programs may be installed from a program source to an apparatus such as a computer. The program source may be, for example, a storage medium from which a program distribution server or a computer can read the programs. In the case of the program source being a program distribution server, it is all right if the program distribution server includes a processor and a storage resource storing programs to be distributed, and the processor in the program distribution server distributes the programs to be distributed to other computers. In addition, in the following descriptions, two or more programs may be materialized as one program, and one program may be materialized as two or more programs.

Hereinafter, the case where a repair support system and a repair support method according to the present embodiment are applied to an ATM will be explained in detail, but applied to fluid mechanics will be described in detail, but the repair support system and the repair support method can be applied not only to the ATM but also to various apparatuses and instruments.

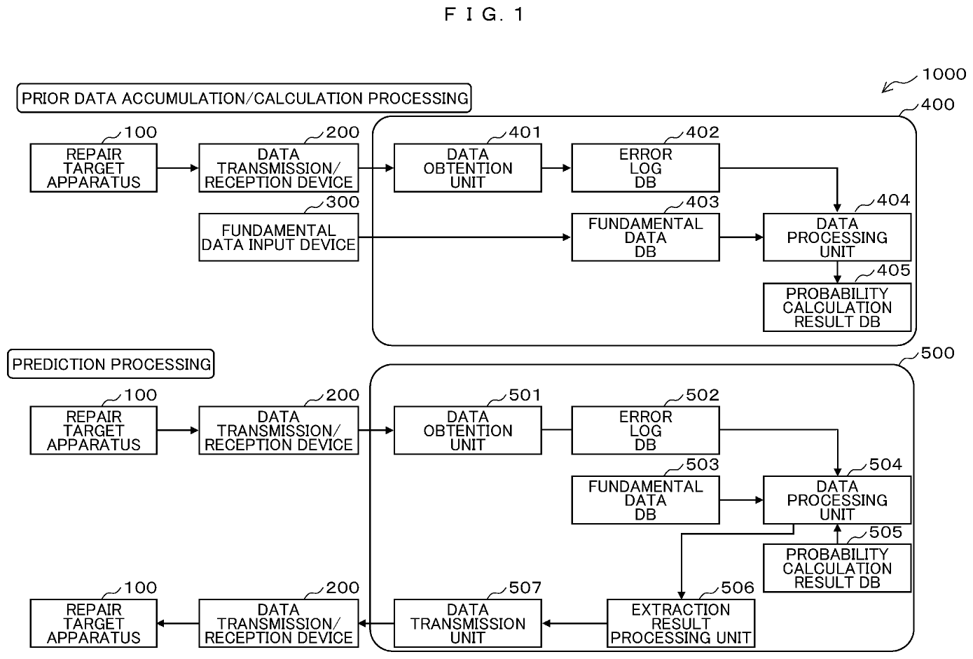

FIG. 1 is a block drawing showing a functional configuration example of a repair support system 1000 according to the present embodiment. As shown in FIG. 1, the repair support system 1000 includes a prior processing server 400 and a prediction server 500.

The prior processing server 400 includes: a data obtention unit 401 for receiving error logs and repair/replacement parts data outputted by a repair target apparatus 100 from a data transmission/reception device 200; an error log DB 402 for storing data outputted by the data obtention unit 401; a fundamental data DB 403 inputted by a fundamental data input device 300 that inputs fundamental data regarding the repair target apparatus 100; a data processing unit 404 that performs processing and calculation of data to be stored in a probability calculation result DB 405 using the error log 402 and the fundamental data DB 403; and a probability calculation result DB 405 for storing the results of the processing performed by the data processing unit 404.

The prediction server 500 includes: a data obtention unit 501 that receives error logs at the times of repairs outputted by the repair target apparatus 100 from the data transmission/reception device 200; an error log DB 502 for storing data outputted by the data obtention unit 501; a fundamental data DB 503 similar to the fundamental data DB 403 included by the prior processing server 400; a data processing unit 504 that performs processing and calculation of data used for referring to a probability calculation result DB 505 using the error log 502 and the fundamental data DB 503; the probability calculation result DB 505 which is referred to using the results of the processing performed by the data processing unit 504; an extraction result processing unit 506 that extracts recommendable repair information provided to a user using a reference result obtained by referring to the probability calculation result DB 505; and a data transmission unit 507 that transmits the recommendable repair information extracted by the extraction result processing unit 506 to the data transmission/reception device 200. Here, arrows in FIG. 1 show the flows of data. The recommendable repair information will be described later with reference to FIG. 16.

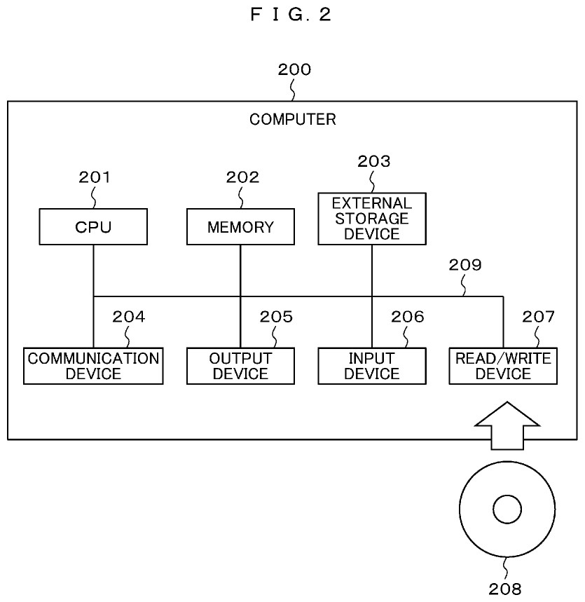

Each of the abovementioned servers can be materialized by, for example, a typical computer 200 as shown in FIG. 2 (a schematic diagram of a computer), where the typical computer includes: a CPU 201; a memory 202; an external storage device 203 such as an HDD (Hard Disk Drive); a read/write device 207 that reads information from or writes information in a portable storage medium 208 such as a CD (Compact Disk) or a DVD (Digital Versatile Disk); an input device 206 such as a keyboard or a mouth; an output device 205 such as a display; a communication device 204 such as a NIC (Network Interface Card) used for connection to a communication network; internal communication lines 209 (hereinafter referred to as system buses) such as system buses used for connecting the above devices.

For example, each DB of the error log DB, the fundamental data DB, the probability calculation result DB, and the like, which are stored by each server, can be materialized by the CPU 201 reading out each DB from the memory 202 or the external storage device 203 and using each DB. In addition, the data obtention unit and the data processing unit possessed by each server, and the extraction result processing unit 506 and the data transmission unit 507 possessed by the prediction server 500 can be materialized by the CPU 201 loading predefined programs, which are stored in the external storage device 203, into the memory 202 and executing the predefined programs. Furthermore, each server may possess an input unit the input function of which can be materialized by the CPU 201 activating the input device 206. In addition, each server may possess an output unit the output function of which can be materialized by the CPU 201 activating the output device 205. Furthermore, each server may possess a communication unit the communication function of which can be materialized by the CPU 201 activating the communication device 204. In the present embodiment, it will be assumed that the function played by the abovementioned communication unit is possessed by each of the data obtention units of both servers and the data transmission unit of the prediction processing server 500.

It is conceivable that the abovementioned predefined programs are stored on (downloaded into) the external storage device 203 from the storage medium 208 via the read/write device 207 or from a network via the communication device 204, and subsequently the predefined programs are loaded into the memory 202 so as to be executed by the CPU 201. Alternatively, it is also conceivable that the predefined programs are directly loaded into the memory 202 from the storage medium 208 via the read/write device 207 or from the network via the communication device 204 and executed by the CPU 201.

Although, in the following description, the respective units of the prior processing server 400 and the prediction server 500 are implemented as hardware devices in a typical computer, functions similar to the functions of the respective units may be materialized by implementing all of these units or parts of these units in one computer or in plural computers distributedly in the form of a cloud and by making these units communicate with one another, or both prior processing server 400 and prediction server 500 may be materialized by one server. The operations of the respective units of the prior processing server 400 and the prediction server 500, and data held by these servers will be explained with reference to flowcharts below.

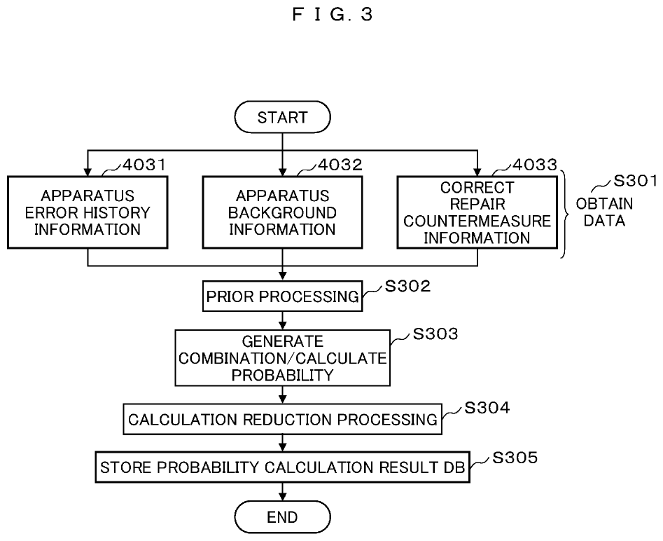

FIG. 3 is a diagram showing an example of a flowchart for prior data accumulation/calculation processing performed by the prior processing server 400. In the following descriptions, it will be assumed that the prior data accumulation/calculation processing is performed every time the repair target apparatus 100 fails to operate properly and is repaired.

The data obtention unit 401 of the prior processing server 400 obtains apparatus error history information 4031 showing the histories (logs) of the repair target apparatus 100 and parts thereof from the repair target apparatus 100 or the data transmission/reception device 200 at the timing the repair target apparatus 100 fails to operate properly, the repair of the repair target apparatus 100 is executed, or the repair is finished, and the repair target apparatus 100 stores the apparatus error history information 4031 in the error log DB 402 (S301). At the timing before this repair event is executed, at the timing this repair event is being executed, at the timing after this repair event is finished, or at any of the above timings, the prior processing server 400 obtains various types of data to be stored in the fundamental data database 403 from the fundamental data input device 300, and the various types of data obtained from the fundamental data input device 300 is stored in the fundamental data DB 403. The various types of data includes: apparatus background information that is business knowledge regarding the repair target apparatus such as the installation region of the repair target apparatus 100 (for example, Indonesia), the installation date (for example, October 2010), the operation achievement and the part replacement achievement (for example, no rubber replacement achievement within the last six months), parts, the manufacturing date (for example, 2010) and the model name of the apparatus, and the model name of the apparatus; apparatus background information 4032 including condition information (to be described later) defining prior conditions for calculations executed by the data processing unit 404; and correct repair countermeasure information 4033 showing actual countermeasure methods at the time errors occur (for example, a repair countermeasure for a rubber roller). The data processing unit 404 reads out these pieces of information, that is to say, past error logs that are considered as causes for failures corresponding to correct repair data at the time the relevant failures of the repair target apparatus occurred, and failure cause data such as dates, regions, and operation hours from the fundamental data DB 403.

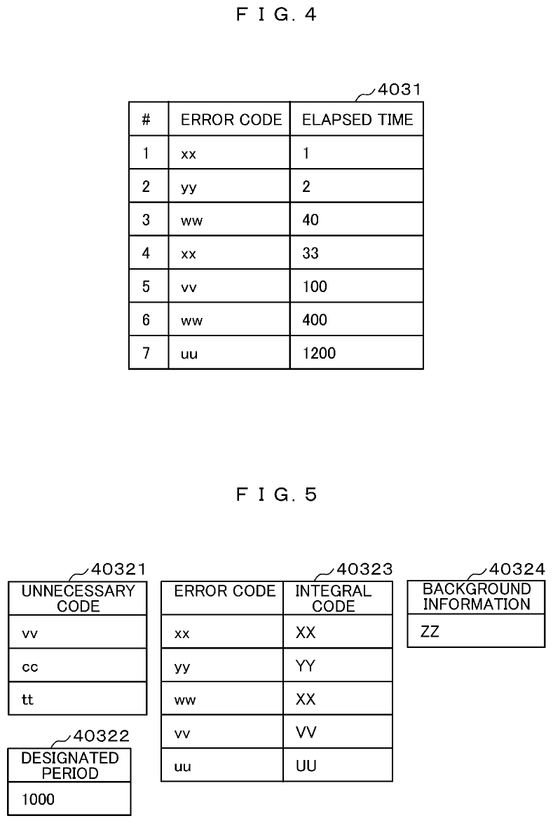

FIG. 4 is a diagram showing an example of the apparatus error history information 4031. As shown in FIG. 4, in the apparatus error history information 4031, the serial numbers of recorded error codes (#), error codes that are examples of information showing errors that occurred in the repair target apparatus 100 and parts thereof, and elapsed times that are time periods from the times the relevant error codes appeared to the current time are recorded in such a way that a serial number, an error code, and an elapsed time for each repair event are associated with one another. As for the elapsed times, it will be assumed that these elapsed times are calculated in advance by the repair target apparatus 100 or by parts thereof.

In FIG. 4, for example, an error code “xx” with the serial number 1 shows information one hour before the data obtention unit 401 obtained the apparatus error history information 4031, and an error code “uu” with the serial number 7 shows information 1200 hours before the data obtention unit 401 obtained the apparatus error history information 4031.

FIG. 5 is a diagram showing examples of condition information and background information included in the apparatus background information 4032. FIG. 5 illustrates unnecessary code list data 40321, designated period data 40322, and code conversion data 40323 as the condition information. Furthermore, FIG. 5 illustrates background information data 40324 as the background information.

The unnecessary code list data 40321 is data in which a list of error codes unnecessary for the repair prediction of error codes obtained by the data obtention unit 401 is registered. In the case of the repair target apparatus 100 including complex mechanisms inside such as an ATM, since error codes other than error codes to be repaired (for example, warning information showing the shortage of the number of bills to be always accommodated in the repository box of the ATM) are outputted, such error codes are registered in advance as unnecessary codes. FIG. 5 shows that an error code “vv” is registered as an unnecessary code, for example.

The designated period data 40322 is data in which a certain period is registered, where, among the error codes obtained by the data obtention unit 401, error codes the elapsed times of which are equal to the certain period or more are excluded from the processing. FIG. 5 shows that error codes the elapsed times of which are equal to 1000 hours or more are excluded from the processing.

The code conversion data 40323 is a conversion table used for grouping error codes, the contents of which are similar to one another, of error codes obtained by the data obtention unit 401 into some groups. FIG. 5 shows that, for example, both error codes “xx” and “ww” are converted into integral codes “XX”.

The background information data 40324 is information representing a background or an environment in which the repair target apparatus 100 needs to be repaired, and includes the abovementioned information regarding the repair target apparatus 100 and parts. FIG. 5 shows that “zz” is registered as information representing a background or an environment that shows the abovementioned business knowledge regarding to the repair target apparatus.

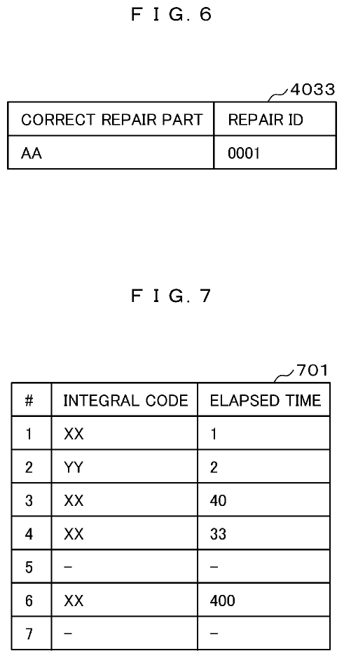

In addition to the abovementioned information, the fundamental data DB 403 stores correct repair countermeasure information 4033 that shows countermeasure contents in past repairs. FIG. 6 is a diagram showing an example of correct repair countermeasure information 4033. As shown in FIG. 6, the correct repair countermeasure information 4033 stores the ID of a past repair event and the countermeasure content of the relevant repair in such a manner that the ID and the countermeasure content (in this case, a repaired part) are associated with each other. FIG. 6 shows that repairing a part “AA” is taken as a countermeasure against a repair event “0001”. Although FIG. 6 illustrates repairing a part as a countermeasure content, maintenance contents such as replacing a part and taking no countermeasure without replacing or repairing a part other than repairing a part are also stored.

Returning the explanation to FIG. 3, the data processing unit 404 performs prior processing on a data group in which pieces of information for each repair event are prepared in both abovementioned error log DB 402 and fundamental data DB 403 in the prior processing server 400 (S302). The prior processing is processing to process the obtained data with the aim of alleviating the after-mentioned probability calculation processing and improving accuracy thereof.

To put it concretely, the data processing unit 404 deletes a record including an error code registered in the unnecessary code list data 40321 from the apparatus error history information 4031 with reference to the apparatus error history information 4031 and the unnecessary code list data 40321. For example, the data processing unit 404 deletes a record with a serial number 5 that is a record including an error code “vv” registered in the unnecessary code list data 40321 as an unnecessary code from the apparatus error history information 4031 shown in FIG. 4.

In addition, the data processing unit 404 deletes a record including an elapsed time before a designated period registered in the designated period data 40322 from the apparatus error history information 4031 with reference to the apparatus error history information 4031 from which the unnecessary code has been deleted and the designated period data 40322. For example, the data processing unit 404 deletes a record with a serial number 7 that is a record including an elapsed time before a period “1000” hours registered in the designated period data 40322 as a designated period from the apparatus error history information 4031 shown in FIG. 4.

Furthermore, the data processing unit 404 identifies records including error codes registered in the code conversion data 40323 in the apparatus error history information 4031 with reference to the apparatus error history information 4031 from which the unnecessary code and the code deviating from the designated period have been deleted and the code conversion data 40323, and converts each of the error codes of the identified records into an integral code. For example, the data processing unit 404 identifies a record with the serial number 1 including the error code “xx” and a record with the serial number 3 including the error code “ww”, which are both registered as error codes to be converted into code conversion data 40323, from the apparatus error history information 4031 shown in FIG. 4, and converts the error codes of these identified records into the integral codes “XX” respectively.

The apparatus error history information 4031 from which the unnecessary code and the code deviating from the designated period are deleted and in which the conversion into the integral codes is executed becomes in a state as shown apparatus error history information 701 in FIG. 7. From FIG. 7, it can be understood that the integral codes into which the error codes are converted and elapsed times are associated respectively and records with serial numbers 5 and 7 are deleted (−).

Subsequently, the data processing unit 404 counts the number of each integral code stored in the apparatus error history information 4031 from which the unnecessary code, the code deviating from the designated period are deleted and in which the conversion into the integral codes is executed, and generates an integral code table in which each of codes that appear plural times is redefined as a new integral code. As described later, error code groups including the integral codes and newly-redefined integral codes are stored in the integral code table.

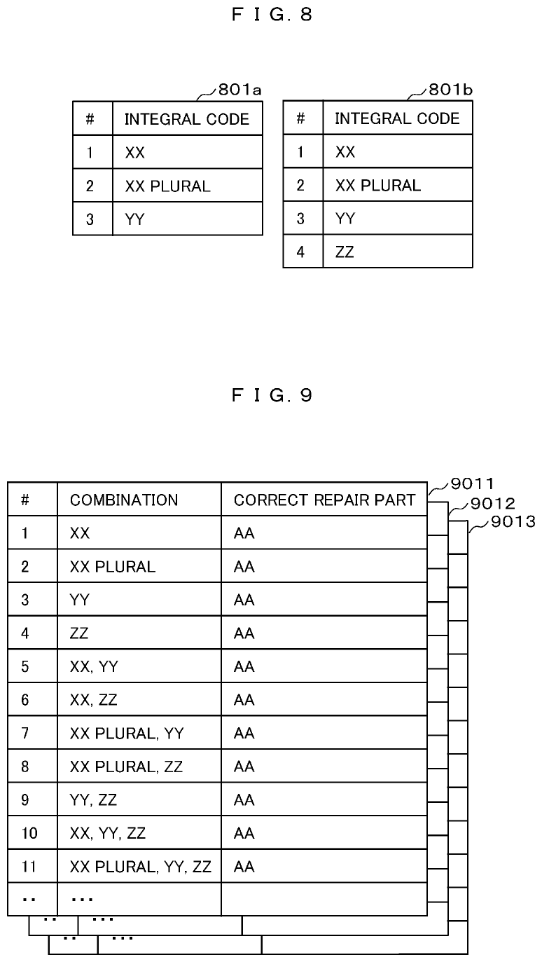

FIG. 8 is a diagram showing examples of integral code tables redefined by the data processing unit 404. As shown in FIG. 8, the serial number (#) of each integral code and the value of each integral code having the relevant serial number are stored in association with each other in the integral code table 801a. In FIG. 8(a), for example, when it comes to an error code “XX”, the data processing unit 404 shows that a redefined integral code table 801a is generated by giving a serial number 1 to an integral code “XX” showing that the relevant code appears and a serial number 2 to an integral code “XX plural” showing that the relevant code appears plural times. In FIG. 7, since each of records having serial numbers 1, 3, 4, and 5 has an error code “XX”, it can be understood that the integral code table 801a including a record that redefines the above integral code “XX plural” regarding the relevant code is generated. Although, in the present embodiment, an error code that appears at least twice is redefined as a new code, it is also conceivable that, a threshold of the appearance number of times (N times) for codes is preset depending on a repair target apparatus, the types of parts, a usage environment under which a repair target apparatus or parts thereof are used, a setting environment under which a repair target apparatus or parts thereof are set, or the like, and when a code the appearance number of times of which is equal to the threshold or more appears, the data processing unit 404 redefines the code as a new code. In addition, it is also conceivable that the data processing unit 404 presets plural thresholds like the above in accordance with the types of error codes, and when any error code the appearance number of times of which is equal to the relevant threshold or more appears, the data processing unit 404 redefines the code as a new code. As for these thresholds, by pre-calculating a probability that can provide correct prediction and setting the best conditions to these thresholds, it becomes possible to improve the accuracy of prediction.

Furthermore, the data processing unit 404 generates an integral code table 801b obtained by adding the background information data 40324 to the generated integral code table 801a. It can be understood that, in FIG. 8(b), the integral code table 801b is generated by adding “ZZ” with a serial number 4 to the integral code table 801a shown in FIG. 8(a) as the background information data 40324.

Returning the explanation to FIG. 3, after the processing at S302 is finished, the data processing unit 404 performs combination generation and probability calculation processing (S303).

To put it concretely, the data processing unit 404 generates a combination countermeasure table that associates combinations (error code groups) each of which is composed of one or plural integral codes stored in the integral code table 801b with the countermeasure contents at the appearance times of error codes that are the sources of the integral codes included in the integral code table 801b respectively.

FIG. 9 is a diagram showing examples of combination countermeasure tables. FIG. 9 shows that combination countermeasure tables 9011, 9012, and 9013 for respective repair events at the times the repair target apparatus 100 is maintained at three different timings are generated. In other words, the number of combination countermeasure tables is incremented every time a new repair event occurs.

As shown in FIG. 9, the serial number (#) of each combination, an integral code included in the relevant combination, and a countermeasure content (in FIG. 9, a correct repair part) at the time that an error code, which is the source of the relevant integral code, appears are stored in association with one another in a combination countermeasure table. A correct repair part against each combination can be obtained by the data processing unit 404 tracing the correct repair countermeasure information 4033 shown in FIG. 6. FIG. 9 shows that a repair part “AA” is stored regarding combinations “XX” and “XX plural” for example. Here, it will be assumed that a combination of a single integral code (for example, “XX”) and plural integral codes (for example, “XX plural”) is not generated, and swapping integral codes is excluded (for example, a combination of “YY, XX” obtained by swapping the order of “XX” and “YY” of a combination of “XX, YY” is excluded).

The data processing unit 404 generates a countermeasure table for each repair event in this way, and subsequently performs probability calculation processing. For example, the data processing unit 404 calculates a support factor for each combination stored in the combination countermeasure table 9011. A support factor, for example, regarding the integral codes XX, YY, and a repair part AA can be calculated using the following calculation expression.

[Expression 1]

Support Factor(XX,YY|AA)=number of data including{XX,YY,AA}/total number of data (Expression 1)

By calculating a support factor (Support) for each combination using the above calculation expression, information for making a judgment whether the relevant combination is a combination of high-frequency error codes or not can be obtained.

In addition, the data processing unit 404 calculates a confidence factor (Confidence) for each combination stored in the combination countermeasure table 9011 as a piece of probability calculation processing. A confidence factor, for example, regarding the integral codes XX, YY, and the repair part AA can be calculated using the following calculation expression.

[Expression 2]

Confidence Factor(XX,YY|AA)=Number of Data Including{XX,YY,AA}/Number of Data Including{XX,YY} (Expression 2)

By calculating a confidence factor for each combination using the above calculation expression, the probability the occurrence of a specific repair against a certain error code can be calculated.

Furthermore, the data processing unit 404 calculates a lift value (Lift) for each combination stored in the combination countermeasure table 9011 as a piece of probability calculation processing. A lift value, for example, regarding the integral codes XX, YY, and the repair part AA can be calculated using the following calculation expression.

[Expression 3]

Lift Value(XX,YY|AA)=[Number of Data Including{XX,YY,AA}/Number of Data Including{XX,YY}]/[Number of Data Including{AA}/Total Number of Data] (Expression 3)

By calculating a lift value for each combination using the above calculation expression, it becomes possible to exclude repairs that frequently occur independently of logs.

In the present embodiment, it is not recommendable to take a countermeasure against a combination having a lift value equal to 1 or less.

After performing these pieces of probability calculation processing, the data processing unit 404 performs calculation reduction processing for excluding combinations that do not satisfy a threshold that is defined in advance (S304). For example, the data processing unit 404 excludes combinations the lift values of which are less than a threshold “1”. In addition, the data processing unit 404 excludes combinations the support factors of which are less than a threshold “0.1”.

The data processing unit 404 stores a combination countermeasure table including combinations other than the combinations excluded by the calculation reduction processing; and data including the number of combinations, a support factor, a confidence factor, and a lift value for each combination with association with one another as a probability calculation result DB 405 (S305).

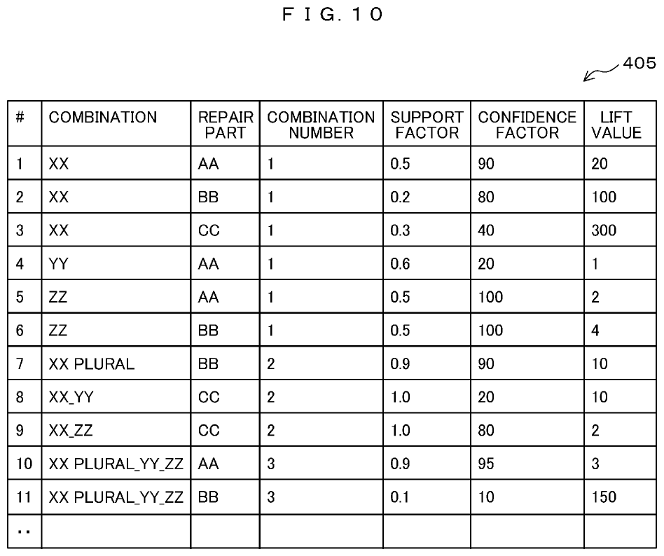

FIG. 10 is a diagram showing an example of a probability calculation result DB 405. As shown in FIG. 10, the probability calculation result DB 405 stores a serial number (#) for each combination, an integral code for the relevant combination, a countermeasure content at the time an error code that is a source of the relevant integral code appears (in FIG. 10, a correct repair part) in association with one another. FIG. 10 shows that, for example, the support factor of a repair part “BB” corresponding to a combination “XX plural” is “0.9”, the confidence factor is “90”, and the lift value is “10”. Furthermore, the combination “XX plural” shows that the appearance number of times of an integral code that is a source is 2 or more.

When the processing at S305 is finished, the prior data accumulation/calculation processing performed by the prior processing server 400 shown in FIG. 3 is finished. In the above-described example, as for countermeasures that have already been decided against error codes or integral error codes, the fundamental data input device 300 or the data obtention unit 401 may store the countermeasure contents in advance in the fundamental data DB 403.

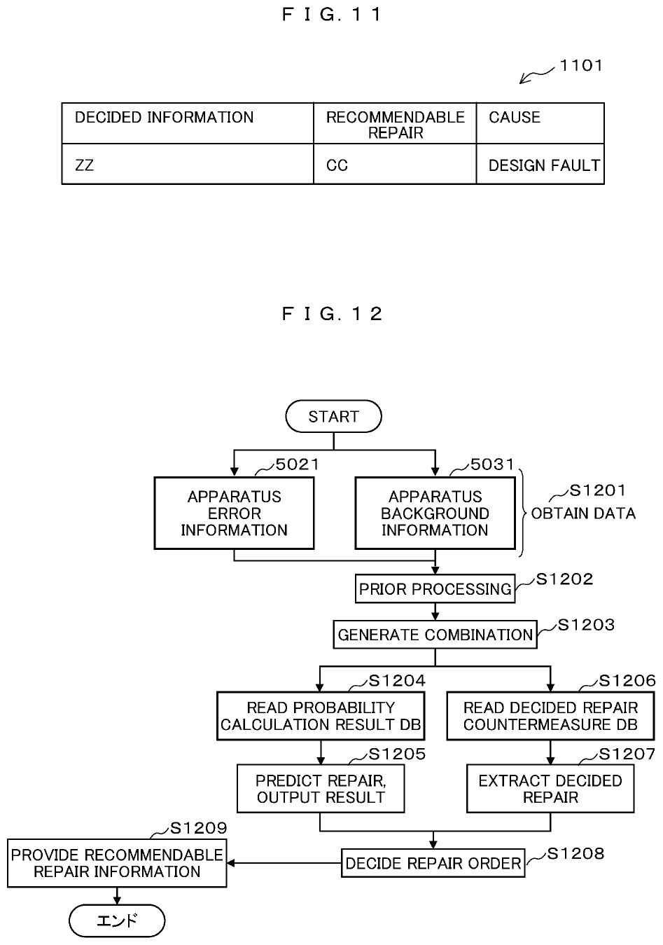

FIG. 11 is a diagram showing an example of decided repair information storing information regarding countermeasures decided against an error code or an integral error code. As shown in FIG. 11, the decided repair information 1101 stores decided information showing an error code or an integral error code that needs any kind of countermeasure (for example, repair), a recommendable countermeasure (for example, recommendable repair) that shows a countermeasure (for example, repair) recommended as a countermeasure against the relevant decided information, and a cause why the relevant countermeasure is needed in association with one another. FIG. 11 shows, for example, that a recommendable repair against an error code or an integral error code regarding a decided information “ZZ” is “CC” (for example, replacement), and that the cause is “design fault”.

Subsequently, prediction processing performed by the prediction server 500 will be explained. FIG. 12 is a diagram showing an example of a flowchart for the prediction processing performed by the prediction server 500. In the following description, it will be assumed that the prediction processing is performed every time a new failure occurs in the repair target apparatus 100.

The data obtention unit 501 of the prediction sever 500 newly obtains apparatus error information 5021 showing the history (logs) regarding error information of the repair target apparatus 100 or parts thereof from the repair target apparatus or the data transmission/reception device 200 at the timing a new failure occurs in the repair target apparatus 100 or at the timing a repair against the failure is started, and stores the apparatus error information 5021 in the error log DB 502 (S1201). At this time, the data obtention unit 501 of the prediction server 500 reads out various kinds of data included in the fundamental data DB 503 similar to the fundamental data DB 403 generated in the prior processing server 400. For example, the data obtention unit 501 reads out, as the various kinds of data, apparatus background information 5031 which is similar to the apparatus background information 4032 and that includes background information of the repair target apparatus 100 such as the installation site, the installation date, the operation achievement, the part replacement achievement, and the parts of the repair target apparatus 100, the manufacturing date and model name of the apparatus, and condition information that defines prior conditions for calculation executed by the data processing unit 504.

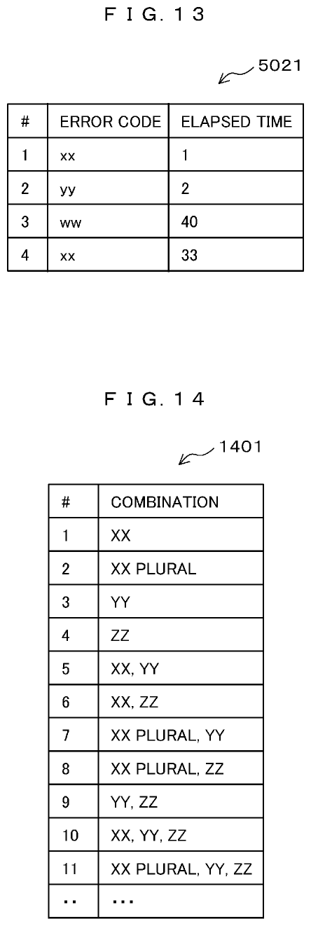

FIG. 13 is a diagram showing an example of the apparatus error information 5021 obtained by the data obtention unit 501 of the prediction server 500. Items that exist at the time a new failure occurs and that are similar to the items included in the apparatus error history information 4031 shown in FIG. 4 is stored in the apparatus error information 5021. Since these items are similar to the items shown in FIG. 4, explanation about these items will be omitted here.

Subsequently, the data processing unit 504 reads out the error log DB 502 and the apparatus background information 5031 and performs prior processing as is the case with the data processing unit 404 of the prior processing server 400 (S1202). After finishing the processing at S1202, the data processing unit 504 performs the generation of combinations (S1203). To put it concretely, using the apparatus error information 5021 at the time the new failure occurs, which is shown in FIG. 13, the data processing unit 504 generates a combination table that stores one integral code or a combination of plural integral codes stored in an integral code table similar to the integral code table 801b generated by the data processing unit 404 of the prior processing server 400.

FIG. 14 is a diagram showing an example of a combination table 1401. As shown in FIG. 14, the serial number (#) of each combination and an integral code included in the relevant combination are stored in association with each other in the combination table. Since these items are similar to the items shown in FIG. 9, explanation about these items will be omitted here.

Afterward, the data processing unit 504 reads out the probability calculation result DB 505 that is similar to the probability calculation result DB 405 generated by the data processing unit 404 of the prior processing server 400 (S1204), extracts an integral code corresponding to each combination included in the combination table 1401; a recommendable repair that is a countermeasure content (for example, a correct repair part) at the appearance time of an error code that is the source of the relevant integral code; a confidence factor; and a lift value, and outputs them as a repair prediction result by comparing the read-out probability calculation result DB 505 with the combination table 1401 generated at S1203 (S1205). A support factor may be included in the relevant repair prediction result.

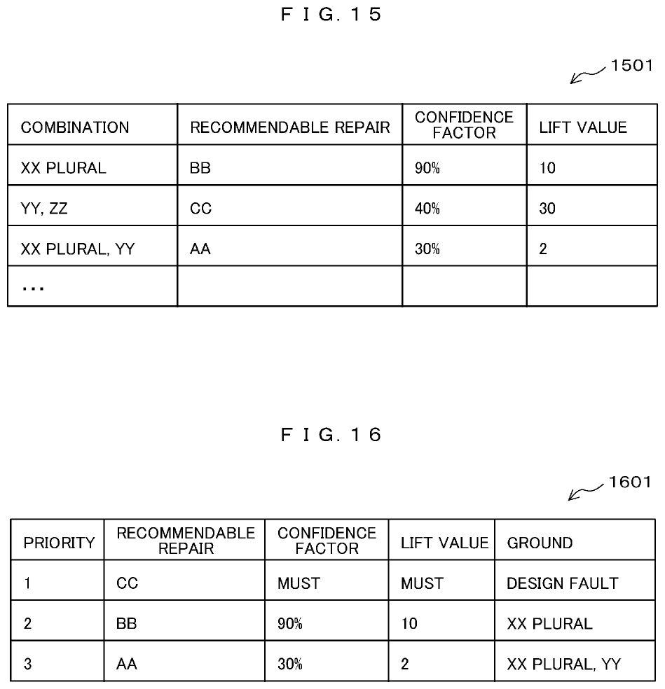

FIG. 15 is a diagram showing an example of a repair prediction result 1501. As shown in FIG. 15, the repair prediction result 1501 stores each combination of the combination table 1401, a recommendable repair that is the above countermeasure content that is associated with the relevant combination and stored in the probability calculation result DB 505, a confidence factor, and a lift value in association with one another. In FIG. 15, it can be understood that, for example, “BB” is recommended as a countermeasure content against a combination “XX plural”, and the relevant confidence factor and lift value are 90% and 10 points respectively. In FIG. 15, the data processing unit 504 arranges records in descending order of the confidence factors of the records, and outputs the repair prediction result 1501.

In addition, the data processing unit 504 reads out decided repair information similar to the decided repair information 1101 (FIG. 11) stored in the prior processing server 400 from the fundamental data DB 503 (S1206), and extracts decided information including an integral code corresponding to each combination included in the combination table 1401, a recommendable repair, and a cause (S1207).

The result extraction processing unit 506 integrates the decided repair information extracted from the fundamental data DB 503 and the repair prediction result 1501, and decides the order of recommendable repairs displayed as recommendable repair information that is eventually provided to a user (S1208). Furthermore, the result extraction processing unit 506 outputs the recommendable repair information including the decided order to the data transmission unit 507, and the data transmission unit 507 provides the recommendable repair information to the user (S1209). As one of methods for providing the recommendable repair information, it is conceivable that the data transmission unit 507 transmits the above recommendable repair information to the data transmission/reception device 200, and the data transmission/reception device 200 makes the display unit display the recommendable repair information.

FIG. 16 is a diagram showing an example of the recommendable repair information 1601 after the result extraction processing unit 506 decided the order. As shown in FIG. 16, priorities for the arrangement, recommendable repairs, confidence factors, lift values, and grounds for the recommendable repairs are stored in association with one another in the recommendable repair information. In the case where the decided repair information can be extracted, the result extraction processing unit 506 judges that the relevant countermeasure is an indispensable countermeasure and arranges the recommendable information in such a way that the decided repair information is disposed in the uppermost position, and sets values (for example, musts) indicating that the relevant confidence factor and the relevant lift value are indispensable to the relevant confidence factor and the relevant lift value. In addition, the result extraction processing unit 506 sets a cause for the decided repair information to the relevant ground. Furthermore, the result extraction processing unit 506 arranges the repair prediction result 1501 in descending order of confidence factors, and sets combinations to grounds.

In FIG. 16, it can be understood that the highest priority “1” is provided to a recommendable repair “CC” included in the decided repair information, “must” is provided to each of the confidence factor and the lift value of the relevant recommendable repair, and it is provided that a ground for them is “design fault”. In addition, it can be understood that the next highest priority “2” is provided with a recommendable repair “BB” having the highest confidence factor of recommendable repairs included in the repair prediction result 1501, “90%” and “10 points” are provided to the confidence factor and the lift value of the relevant recommendable repair respectively, and it can also be understood that the fact that the integral error code appears plural times as shown by “XX plural” is provided as a ground for them. Since such recommendable repair information 1601 are provided to a user, the user can easily specify a true failure portion on the basis of the provided information.

As described above, the repair support system according to the present embodiment includes: a probability calculation result database (for example, the probability calculation result DB 405) including a combination countermeasure table (for example, the combination countermeasure table 9011) in which an error code group including an error code (for example, an error code “XX”) of the repair target apparatus 100 and a plurality error code (for example, “XX plural”) which indicates that the relevant error code appeared plural times in the past and a countermeasure content against each of the error code and the plurality error code are associated with each other and stored, and probabilities (for example, support factors, confidence factors, and lift values) that the countermeasure content against the error code and the countermeasure content against the plurality error code are taken respectively where the probabilities are obtained from predefined calculation formulas (for example, Expression 1 to Expression 3); a data processing unit (for example, the data processing unit 504) that performs combination generation processing for generating a combination table (for example, the combination table 1401) containing a new error code and a new plurality error code from apparatus error information (for example, the apparatus error information 5021) obtained from the repair target apparatus 100, and repair prediction processing for predicting recommendable countermeasure contents against the new error code and the new plurality error code on the basis of the above combination table and the above probability calculation result database; and a result processing unit (for example, the data processing unit 505) for providing, to a user, the results of the above repair prediction processing in order, so that information for making a judgment to specify a true failure portion can be accurately provided.

Furthermore, the repair support system includes a data obtention unit (for example, the data obtention unit 401) that obtains log information (for example, the apparatus error history information 4031) in the past including error codes from the repair target apparatus 100, in which the above data processing unit counts the appearance number of times of each of the error codes included in the above log information, and generates the above probability calculation result database including the above combination countermeasure table in which the above error code group which includes an error code that is counted a plurality of times and that is defined as the plurality error code and the above countermeasure contents are associated with one another and stored, so that data used for the above repair prediction processing can be accumulated in advance and provided.

In addition, the above data obtention unit obtains apparatus background information that is business knowledge regarding the above repair target apparatus from the above repair target apparatus or from other apparatuses, and the above data processing unit generates the above combination countermeasure table including a combination of the above error code and the above background information and a combination of the above plurality error code and the above background information, so that a user can provide information used for executing countermeasures such as repairs while taking business knowledge regarding the repair target apparatus into consideration.

Furthermore, the above result processing unit, as the results of the above repair prediction processing, outputs probability calculation result information including the above recommendable countermeasure contents, the probabilities that the above countermeasure contents are taken, and the above error code or the above plurality error code that shows a ground for recommending the above relevant countermeasure content to a display unit, so that a countermeasure to be taken can be judged at first sight.

The above data processing unit reads out decided repair information including information that is information regarding a decided countermeasure against the above error code or against the above integral error code and that shows the above recommendable countermeasure content and the fact that the above countermeasure content is indispensable; and a ground for the above countermeasure content being indispensable from a storage unit, and the above result processing unit, as the results of the above repair prediction processing, outputs the above probability calculation result information and the above decided repair information to the above display unit, so that, if there is an indispensable countermeasure, a user can easily grasp that the relevant countermeasure is necessary even if the user does not have much knowledge.

Conventionally, in the case of an apparatus or an instrument including complex mechanisms inside such as an ATM, it has been difficult in some cases to guess or specify the true failure portion of the apparatus or instrument with the use of only the degree of similarity of an error log taken as a criterion. For example, if an error is issued when a bill is bent at one part A of the ATM because of the malfunction of the ATM and another bill is jammed at another part B, the malfunction at the portion A cannot be solved only by taking a countermeasure against the error at the portion B. In this case, although it is necessary to take a countermeasure against the malfunction at the portion A with the use of experience, skill, or the like of an engineer, storing an error (in this case, the error at the portion A) and the relevant countermeasure against the error in association with each other makes it possible that even an engineer with little experience or skill easily specifies a true failure portion, which leads to the reduction of maintenance costs.

In addition, by finding features of error codes that appear plural times in logs, which could not have been thought of by conventional techniques, it becomes possible to extract rules for accurately executing repairs, so that appropriate repair instructions can be issued. Furthermore, this technology can be applied to a basket analysis for analyzing the features of purchasers. For example, although conventionally a customer who purchases a can of beer (corresponding to an error) or more has been recommended to purchase snacks, as a result of applying the present system, it turns out that a customer who purchases 12 cans of beer (corresponding to a plurality error code) or more can be recommended to purchase tea. In this way, it is possible to show more correct recommendable articles to customers who make bulk purchases.

### REFERENCE SIGNS LIST

1000 . . . Repair Support System
400 . . . Prior Processing Server
401 . . . Data Obtention Unit
402 . . . Error Log DB
403 . . . Fundamental Data DB
404 . . . Data Processing Unit
405 . . . Probability Calculation Result DB
500 . . . Prediction Server
501 . . . Data Obtention Unit
502 . . . Error Log DB
503 . . . Fundamental Data DB
504 . . . Data Processing Unit
505 . . . Probability Calculation Result DB
506 . . . Extraction Result Processing Unit
507 . . . Data Transmission Unit

1. A repair support system comprising:
a probability calculation result database including a combination countermeasure table in which an error code group including an error code of a repair target apparatus and a plurality error code which indicates that the relevant error code appeared a plurality of times in the past, as well as a countermeasure content against each of the error code and the plurality error code are associated with each other and stored, and probabilities that the countermeasure content against the error code and the countermeasure content against the plurality error code are taken respectively where the probabilities are obtained from predefined calculation formulas;
a data processing unit that performs combination generation processing for generating a combination table containing the new error code and the new plurality error code from apparatus error information obtained from the repair target apparatus, and repair prediction processing for predicting recommendable countermeasure contents against the new error code and the new plurality error code on the basis of the combination table and the probability calculation result database; and
a result processing unit for providing, to a user, the results of the repair prediction processing in order.

2. The repair support system according to claim 1, further comprising a data obtention unit that obtains past log information including error codes from a repair target apparatus,
wherein the data processing unit counts the appearance number of times of each of the error codes included in the log information, and generates the probability calculation result database including the combination countermeasure table in which the error code group which includes an error code that is counted a plurality of times and that is defined as the plurality error code and the countermeasure contents are associated with one another and stored.

3. The repair support system according to claim 2,
wherein the data obtention unit obtains apparatus background information that is business knowledge regarding the repair target apparatus from the repair target apparatus or from other apparatuses, and
the data processing unit generates a combination countermeasure table including a combination of the error code and the background information and a combination of the plurality error code and the background information.

4. The repair support system according to claim 1,
wherein the result processing unit, as the results of the repair prediction processing, outputs probability calculation result information including the recommendable countermeasure contents, the probabilities that the countermeasure contents are taken, and the error code or the plurality error code that shows a ground for recommending the relevant countermeasure content to a display unit.

5. The repair support system according to claim 4,
wherein the data processing unit reads out decided repair information including information that is information regarding a decided countermeasure against the error code or against the plurality error code and that shows the recommendable countermeasure content and the fact that the countermeasure content is indispensable; and a ground for the countermeasure content being indispensable from a storage unit, and
the result processing unit, as the results of the repair prediction processing, outputs the probability calculation result information and the decided repair information to the display unit.

6. A repair support method using a computer comprising the steps of:
reading out a probability calculation result database including a combination countermeasure table in which an error code group including an error code of a repair target apparatus and a plurality error code which indicates that the relevant error code appeared a plurality of times in the past, as well as a countermeasure content against each of the error code and the plurality error code are associated with each other and stored, and probabilities that the countermeasure content against the error code and the countermeasure content against the plurality error code are taken respectively where the probabilities are obtained from predefined calculation formulas;
generating a combination table containing the new error code and the new plurality error code from apparatus error information obtained from the repair target apparatus;
predicting recommendable countermeasure contents against the new error code and the new plurality error code on the basis of the combination table and the probability calculation result database; and
providing, to a user, the results of the prediction in order.

7. The repair support method according to claim 6, further comprising the steps of:
obtaining past log information including error codes from a repair target apparatus;
counting the appearance number of times of each of the error codes included in the log information; and
generating the probability calculation result database including the combination countermeasure table in which the error code group which includes an error code that is counted plural times and that is defined as the plurality error code and the countermeasure contents are associated with one another and stored.

8. The repair support method according to claim 7, further comprising the steps of:
obtaining apparatus background information that is business knowledge regarding the repair target apparatus from the repair target apparatus or from other apparatuses; and
generating a combination countermeasure table including a combination of the error code and the background information and a combination of the plurality error code and the background information.

9. The repair support method according to claim 6, further comprising the step of outputting, as the results of the prediction, probability calculation result information including the recommendable countermeasure contents, the probabilities that the countermeasure contents are taken, and the error code or the plurality error code that shows a ground for recommending the relevant countermeasure content to a display unit.

10. The repair support method according to claim 9, further comprising the steps of:
reading out decided repair information including information that is information regarding a decided countermeasure against the error code or against the plurality error code and that shows the recommendable countermeasure content and the fact that the countermeasure content is indispensable; and a ground for the countermeasure content being indispensable from a storage unit; and
outputting, as the results of the prediction, the probability calculation result information and the decided repair information to the display unit.
